(19) United States
(12) Patent Application Publication
(10) Pub. No.: US 2010/0110044 A1
(43) Pub. Date: May 6, 2010

(54) JOG DIAL ACTUATING DEVICE

(75) Inventor: Hakan Mats Englund, Haninge (SE)

Correspondence Address: EDWARDS ANGELL PALMER & DODGE LLP, P.O. BOX 55874, BOSTON, MA, 02205, US

(73) Assignee: SONY ERICSSON MOBILE COMMUNICATIONS AB, Lund (SE)

(21) Appl. No.: 12/265,791

(22) Filed: Nov. 6, 2008

(51) Int. Cl. G09G 5/00

(52) U.S. Cl. 345/184

(57) ABSTRACT

A jog dial actuating device and an electronic device are described.

### BACKGROUND OF THE INVENTION

The present invention relates to a Jog dial actuating device and an electronic device comprising the jog dial actuating device.

### BRIEF SUMMARY OF THE INVENTION

According to an embodiment of the present invention, a jog dial actuating device is provided. The jog dial actuating device comprises a longitudinal member and at least two rotary members, wherein the longitudinal member is movably guided around the at least two rotary members. The jog dial actuating device further comprises a sensor for detecting a movement of the longitudinal member around the at least two rotary members.

Especially in the field of mobile devices, for example a mobile phone or a personal digital assistant (PDA), jog dial type devices are used for scrolling a content displayed on a display of the mobile device. Conventionally, jog dial type devices are composed of a scroll wheel made of plastic or rubbery disposed in such a way in a housing of the mobile device, that a part of the circumference of the wheel protrudes from the housing through an opening of the housing and can be actuated by a user of the mobile device in a rotary direction. However, conventional scroll wheels require a considerable space within the mobile device and with mobile devices becoming smaller, it gets more difficult to provide the space for a conventional jog dial device with a scroll wheel. By composing a jog dial actuating device of at least two rotary members and a longitudinal member movably guided around the at least two rotary members, a jog dial actuating device requiring much less space can be provided. The longitudinal member may be a flexible longitudinal member in the form of a belt, a chain or a track. The at least two rotary members may be pulleys guiding the longitudinal member.

According to an embodiment, the at least two rotary members have a groove and the longitudinal member is guided in the groove when being guided around the at least two rotary members. The groove may help to guide the longitudinal member precisely on the circumference of the rotary members and may therefore help to prevent a gliding off of the longitudinal member from the rotary members.

According to another embodiment, the jog dial actuating device provides a plurality of protrusions on an outer circumferential surface of the longitudinal member. The protrusions may be ribs provided on the outer circumferential surface of the longitudinal member, wherein each rib is essentially aligned in a direction perpendicular to the longitudinal direction of the longitudinal member. The protrusions or ribs provided on the outer circumferential surface of the longitudinal member help a user actuating the longitudinal member in the longitudinal direction and provide a mechanical positioning feedback to the user. With the protrusions or ribs a reliable contact between a finger of the user and the longitudinal member can be provided for a reliable actuation of the longitudinal member by the user.

According to an embodiment, the sensor is adapted to detect a movement of the ribs. Such a sensor may be an optical sensor detecting a movement of the longitudinal member by detecting a changing reflection or a changing occlusion caused by the movement of the ribs.

According to another embodiment, the sensor is coupled to at least one of the rotary members and is adapted to detect a rotation of the at least one rotary member the sensor is coupled to. The sensor may be adapted to detect the rotation direction and the rotation speed of the at least one rotary member the sensor is coupled to. The sensor may be an optical sensor or a magnetic sensor or any other kind of rotary motion sensor known in the art.

According to an embodiment, the sensor is adapted to detect a moving direction of the longitudinal member in a longitudinal direct thereof. Furthermore, the sensor may be adapted to detect a degree of movement of the longitudinal member around the at least two rotary members. By detecting both the moving direction and the degree of movement, the jog dial actuating device allows to navigate and scroll easily and quickly in a content displayed on the mobile device.

According to another embodiment, the jog dial actuating device comprises two rotary members encompassed by the longitudinal member in such a way that the longitudinal member has essentially no slack when running around the two rotary members. The sensor of the jog dial actuating device is coupled to at least one of the two rotary members, is adapted to detect a rotation of the at least one rotary member, and is arranged in an area between the two rotary members and enclosed by the longitudinal member. By using two rotary members and one longitudinal member, for example a belt, a track, or a chain, encompassing the two rotary members, a very space-efficient jog dial actuating device can be achieved. By positioning the sensor for detecting the rotation of at least one of the two rotary members between the two rotary members and being encompassed by the longitudinal member, no additional space for the sensor outside the circumferential surface of the longitudinal member is required. This makes the jog dial actuating device even more compact. Encompassing the two rotary members by the longitudinal member in such a way that the longitudinal member has essentially no slack provides a reliable transmission of movement of the longitudinal member to the two rotary members. Therefore, when a user using the jog dial actuating device moves the longitudinal member in the longitudinal direction of the longitudinal member, i.e. in the circumferential direction of the longitudinal member, this movement is reliably transferred to the rotary members where this movement is detected by the sensor.

According to another embodiment, the jog dial actuating device comprises a switch which is arranged at a position between the at least two rotary members and adjacent to the longitudinal member. The switch is positioned adjacent to an inner circumferential surface of the longitudinal member and therefore enclosed by the longitudinal member. The switch is positioned in such a way that the switch is operable when the longitudinal member is moved in a direction perpendicular to its longitudinal direction. Therefore, the switch can be actuated simply by pressing the longitudinal member in a direction perpendicular to the longitudinal direction of the longitudinal member. Therefore, the jog dial actuating device may be used for navigating and scrolling the content of a mobile device and may additionally be used for selecting items of the content displayed on a display of the mobile device.

According to another aspect of the present invention, a jog dial actuating device comprises a longitudinal member, a first rotary member and a second rotary member and a sensor. The longitudinal member is provided with a plurality of ribs on an outer circumferential surface thereof and the ribs are essentially aligned in a direction perpendicular to a longitudinal direction of the longitudinal member. The longitudinal member is movably guided around the first rotary member and the second rotary member such that the first rotary member and the second rotary member are encompassed by the longitudinal member in such a way that the longitudinal member has essentially no slack when running around the first rotary member and the second rotary member. The longitudinal member may be a belt, a chain, or a track, wherein an inner circumferential surface of the longitudinal member may be in contact with the two rotary members. The sensor is coupled to the first rotary member for detecting a movement of the longitudinal member around the first rotary member and the second rotary member. The jog dial actuating device constructed as defined above, requires very little installation space and is therefore adapted for being used in a mobile device, for example a mobile phone or a personal digital assistant. With the ribs on the outer circumferential surface of the longitudinal member a reliable actuation of the jog dial actuating device can be provided.

According to an embodiment, the jog dial actuating device comprises a switch which is arranged between the first rotary member and the second rotary member. Furthermore, the switch is positioned adjacent to the longitudinal member such that the switch is operable when the longitudinal member is moved in a direction perpendicular to a longitudinal direction of the longitudinal member and perpendicular to the extension direction of the ribs. The jog dial actuating device is therefore preferably adapted for navigating and selecting in a graphical user interface of a mobile device with a single finger only.

According to the present invention, furthermore an electronic device comprising a jog dial actuating device and a housing for housing the jog dial actuating device is provided. The jog dial actuating device comprises a longitudinal member, at least two rotary members with the longitudinal member being movably guided around the at least two rotary members, and a sensor for detecting a movement of the longitudinal member around the at least two rotary members. The housing is provided with a notch or an opening in a surface of the housing, and the jog dial actuating device is mounted in the housing such that a part of the longitudinal member is protruding from the surface of the housing through the notch such that the longitudinal member can be actuated in a longitudinal direction of the longitudinal member from outside the housing.

The electronic device may further comprise a control unit housed in the housing and connected to the sensor of jog dial actuating device. The control unit may be adapted to receive signals from the sensor to process the detected movement of the longitudinal member. The electronic device may be a mobile device, a mobile phone, a personal digital assistant, a mobile navigation system or a mobile computer. The notch or opening in the surface of the housing may be provided on a side surface of the housing such that, when the electronic device is held with one hand by a user, the jog dial actuating device may be actuated with one finger or a thumb of the hand of the user holding the device.

It is to be understood that the features of the embodiments described above may be combined with each other.

### BRIEF DESCRIPTION OF THE DRAWINGS

Hereinafter, exemplary embodiments of the invention will be described with reference to the drawings.

FIG. 1 shows schematically an embodiment of a jog dial actuating device.

FIG. 2 shows a mobile phone comprising a jog dial actuating device of the present invention.

FIG. 3 shows schematically the jog dial actuating device of FIG. 1 in comparison with a conventional jog dial wheel.

FIG. 4 shows schematically an electronic device according to an embodiment of the present invention.

FIG. 5 shows schematically an embodiment of a rotary motion sensor of the jog dial actuating device.

FIG. 6 to FIG. 8 show a timing diagrams of signals of the rotary motion sensor of FIG. 5

### DETAILED DESCRIPTION OF THE INVENTION

In the following, exemplary embodiments of the present invention will be described in detail. It is to be understood that the following description is given only for the purpose of illustrating the principles of the invention and is not to be taken in a limiting sense. Rather, the scope of the invention is defined only by the appended claims and is not intended to be limited by the exemplary embodiments hereinafter.

It is also to be understood that in the following detailed description of the exemplary embodiments, any direct connection or coupling between functional blocks, devices, components or other physical or functional units shown in the drawings or description herein could also be implemented by an indirect connection or coupling.

It is further to be understood that the features of the various exemplary embodiments described herein may be combined with each other unless specifically noted otherwise.

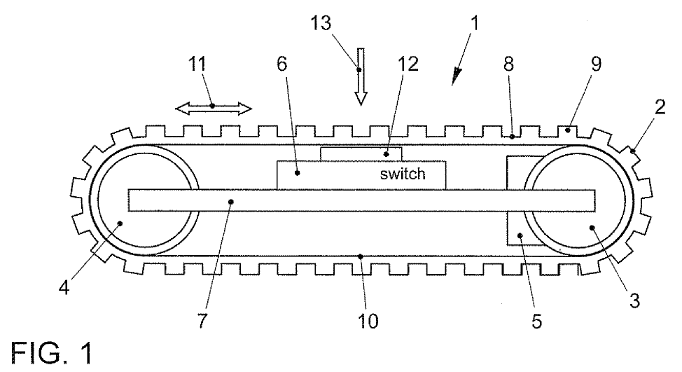

FIG. 1 shows an embodiment of a jog dial actuating device 1 comprising a longitudinal member 2, two rotary members 3,4, a sensor 5 and a switch 6. The rotary members 3, 4 are pivotably mounted at the ends of a support 7 and the switch 6 is mounted near the center of the support 7. The longitudinal member 2 is a continuously closed belt made of an elastic material, for example rubber or plastics. The outer circumference 8 of the longitudinal member 2 is provided with ribs 9 which are arranged on the outer circumference 8 in a direction perpendicular to the longitudinal direction of the longitudinal member 2. An inner circumference 10 of the longitudinal member 2 is in contact with the rotary members 3, 4 and encompasses the rotary members 3, 4. The longitudinal member 2 is mounted around the rotary members 3, 4 in a slightly tensioned manner such that the longitudinal member 2 has no slack and the rotary members 3, 4 are reliably rotated when the longitudinal member is moved in the direction indicated by arrow 11.

The switch 6 is mounted near the center of the distance between the two rotary members 3, 4. The switch 6 is a push button switch with a pushable button 12. The pushable button 12 is located adjacent to the inner circumference 10 of the longitudinal member 2. When a force in the direction of arrow 13 perpendicular to the longitudinal direction of the longitudinal member 2 is applied to the longitudinal member 2, the longitudinal member 2 is moved into the direction of the button 12 and the switch 6 is actuated. When the force in the direction of arrow 13 is released, the longitudinal member 2 moves elastically back in the stretched configuration as shown in FIG. 1 and the switch 6 is also released.

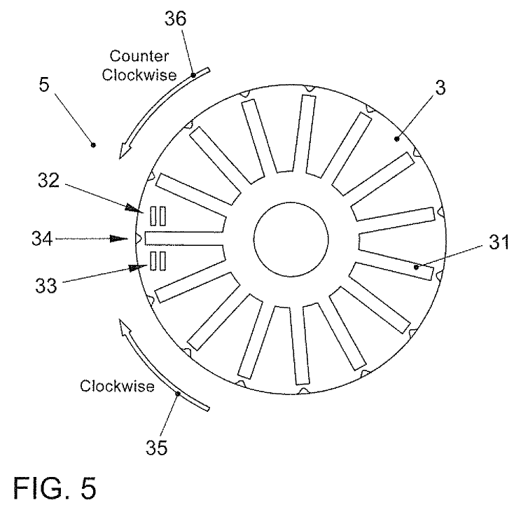

The sensor 5 is a rotary motion sensor detecting a moving direction and a degree of movement of the longitudinal member 2 by monitoring the rotation of the rotary member 3. The sensor 5 may be a rotary motion sensor of any type, for example an inductive, an optic, or a magnetic type. A more detailed description of an embodiment of the rotary motion sensor will be given later in connection with FIG. 5 to FIG. 8.

The jog dial actuating device 1 as described above, is therefore adapted to detect a longitudinal movement in the direction of arrow 11 applied to the longitudinal member 2 and is additionally adapted to detect a pressing force in the direction of arrow 13 applied to the longitudinal member 2 detected by the switch 6.

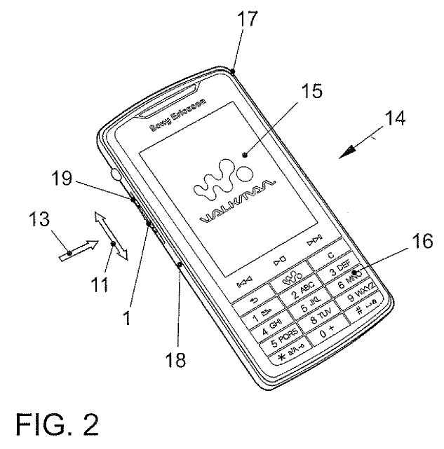

FIG. 2 shows a mobile phone 14 comprising the above-described jog dial actuating device 1. The mobile phone comprises a display 15, several push keys 16 and a housing 17. In a side surface 18 of the housing 17 a notch or opening 19 is provided through which a part of the longitudinal member 2 of the jog dial actuating device 1 of FIG. 1 is protruding. When the mobile phone 14 is for example held in the left hand of the user, the user can put his or her thumb on the protruding part of the longitudinal member 2 of the jog dial actuating device 1 and move the protruding part of the longitudinal member 2 in the direction of arrow 11. By this, the rotary members 3, 4 are pivoted by the movement of the longitudinal member 2 and this rotation is detected by the sensor 5. Furthermore, the user can push the longitudinal member 2 in the direction of arrow 13 for actuating the switch 6 of the jog dial actuating device 1. Therefore the jog dial actuating device 1 can be used for scrolling an navigating information data displayed on the display 15 of the mobile phone 14 and can select items or functions by pressing the longitudinal member 2 in the direction of arrow 13.

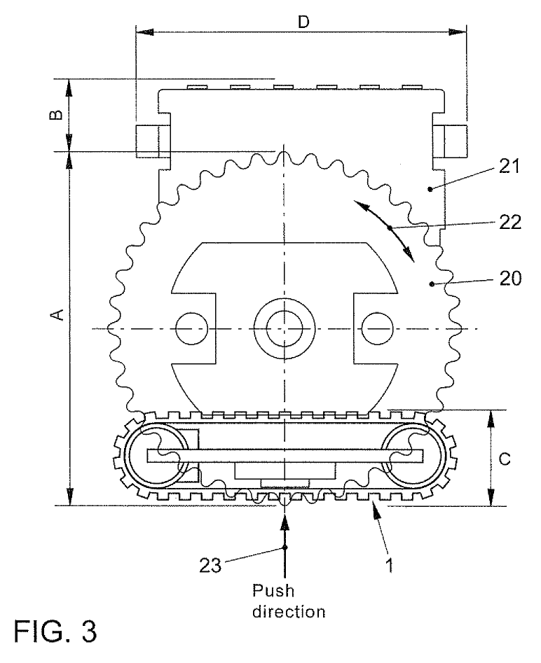

FIG. 3 shows a size comparison between a conventional jog dial wheel 20 and the jog dial actuating device 1 according to an embodiment of the invention. The jog dial wheel 20 is mounted on a support 21 on which the jog dial wheel 20 is rotatable or pivotable in a direction indicated by arrow 22. The support 21 may have a width D in the range of 13 mm, for example. Furthermore, the jog dial wheel 20 is translatable in a push direction 23. For a convenient usage of the jog dial wheel 20, the jog dial wheel 20 has a diameter A of for example 15 mm. The whole arrangement comprising the jog dial wheel 20 and the support 21 requires an area of approximately 15 to 18 mm depending on how far the support 21 extends beyond the jog dial wheel 20 (see distance B in FIG. 3). In contrast to this, as can be seen from FIG. 3, the jog dial actuating device 1 of the present invention requires only a height C of approximately 4 mm. Therefore, the jog dial actuating device 1 requires much less space and area in for example a mobile device like a mobile phone, a mobile navigation system, or a mobile personal digital assistant.

However, the jog dial actuating device of the present invention is not restricted to the above-defined size and the width may be in a range of 8 to 50 mm and the height may be in the range of 2 to 10 mm.

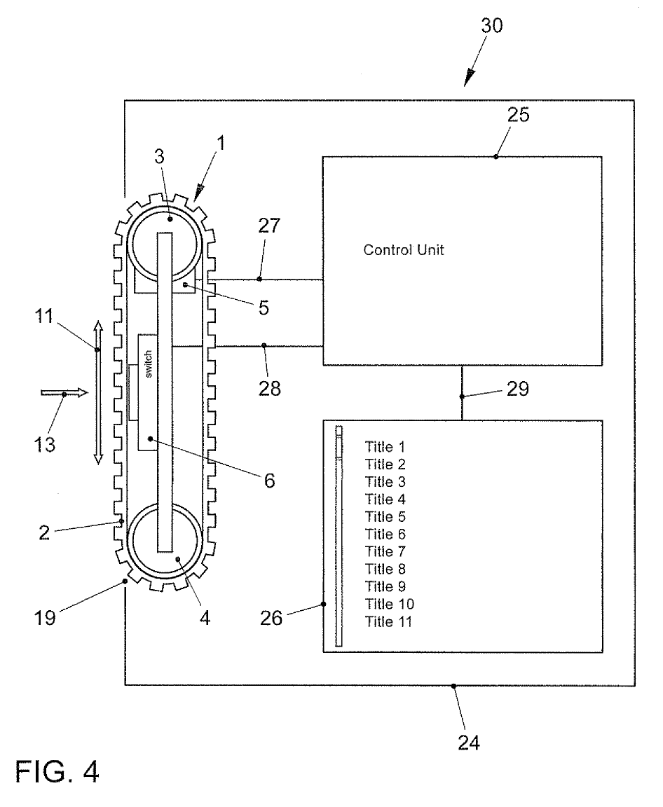

FIG. 4 shows an electronic device 30 comprising a housing 24, a jog dial actuating device 1, a control unit 25 and a display 26. The electronic device 30 may be a mobile device, a mobile phone, a personal digital assistant, a mobile navigation system or a mobile computer. The display 26 may be a liquid crystal display (LCD) which is adapted to display textual and/or graphical information. The control unit 25 may be a microprocessor comprising or coupled with a memory for storing information and a power supply unit, for example a battery. The control 25 unit is coupled with the sensor 5 and the switch 6 of the jog dial actuating device 1.

On the left hand side of the housing 24 of the electronic device 30 a notch or opening 19 is provided and a part of the longitudinal member 2 running stretched from a first rotary member 3 to a second rotary member 4 protrudes through the notch 19 from the housing 24 of the electronic device 30.

As the part of the longitudinal member 2 is protruding from the housing 24 of the electronic device 30 and is therefore accessible from outside of the housing 24 the user of the electronic device 30 can access the longitudinal member 2 and move the longitudinal member 2 in the direction of arrow 11. Furthermore, the user can supply a force on the longitudinal member 2 from outside of the housing 24 in the direction of arrow 13, thus moving the longitudinal member 2 into the direction of switch 6 and thereby operating the switch 6.

The movement of the longitudinal member 2 in the direction of arrow 11 is detected by a rotary motion sensor 5 coupled to the rotary member 3 and the information of sensor 5 is transferred to the control unit 25 via a coupling 27. Another coupling 28 connects the control unit 25 with the switch 6. Therefore, the control unit can evaluate any actuation of the jog dial actuating device 1 in any of the directions indicated by arrows 11 and 13. The control unit 25 is furthermore connected via a coupling 29 to the display 26. In the example shown in FIG. 4 the display 26 shows a list of titles of for example a music data base. By moving the longitudinal member 2 in the direction of arrow 11 the list of titles may be moved up and down in response to the movement of the longitudinal member 2. When pressing the longitudinal member 2 in the direction of arrow 13 a title may be selected for being played.

Finally, in connection with FIG. 5 to FIG. 8, an embodiment of the rotary motion sensor 5 is explained in more detail. FIG. 5 shows a rotary member 3 in combination with a rotary motion sensor 5 comprising spokes 31, a first brush 32 and a second brush 33. The spokes 31 are arranged in a radial direction at the rotary member 3, and the brushes 32, 33 are arranged such that they make and break a connection with the spokes 31 in response to a rotation of the rotary member 3. The making and breaking of the connection with the spokes 31 is detected electrically by the control unit 25 to detect the rotation direction and rotation speed of the rotary member 3. The rotary member 3 furthermore comprises detents 34 which are engageable with a not shown ratchet. The rotary member 3 is movable in the clockwise direction 35 or in the counter clockwise direction 36 depending on the movement of the longitudinal member 2 enclosing the rotary member 3.

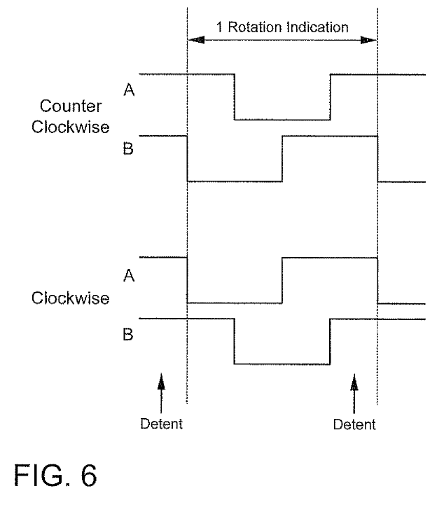

The direction of rotation is determined by the order in which the brushes 32, 33 make and break connection with the spokes 31. An example is shown in FIG. 6. The electrical signal of the first brush 32 is shown as signal A and the electrical signal of the second brush 33 is shown as signal B. Starting from an initial position with A and B being high, one brush contacts the spokes first, followed by the other brush. That first brush then breaks contact with the spokes, again followed by the second brush. The order in which this happens determines the wheel's rotation direction. The waveform of a valid rotation in both the clockwise and counter-clockwise directions are shown in FIG. 6.

In order to ensure that a full rotation indication is produced every time the rotary member 3 is turned, the detents 34 are provided at the rotary member 3. The detents 34 are spaced such that the rotary member 3 comes to rest where both brushes 32, 33 make no contact (i.e., A and B are high) with the spokes 31 of the rotary member 3.

Signal lines of the brushes 32, 33 require pull up resistors. The signal lines of the brushes 32, 33 are brought to a low level by contacting the spokes 31 of the rotary member 3 acting as a switch closure. Due to noise, generated as the rotary member 3 makes and breaks contact with the brushes 32, 33, the corresponding signals are debounced, i.e. as making or breaking a mechanical contact between the brushes 32,33 and the spokes 31 can result in a succession of electrical makes and breaks between the spokes 31 and the brushes 32, 33, this could appear as multiple makes and breaks. Debounce is the process of removing this so that only a single make or break is reported

During operation of the rotary member 3, errors will be detected while monitoring the A and B signals. On startup a default state for both signals is high. If the jog dial actuating device is found with either of its signals low it will generate an error. It will also generate an error if an invalid state transition occurs.

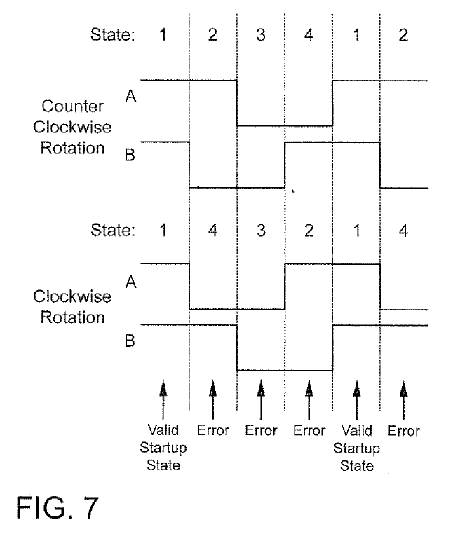

As shown in FIG. 7, during clockwise rotation the A and B signals are cycled through the following sequence starting with default startup state [1]: [1, 4, 3, 2, 1, 4, 3, . . . etc]. Any jump to an unexpected state will generate an error, e.g. [1, 4, 3, 1, 4, 3, 2, . . . etc].

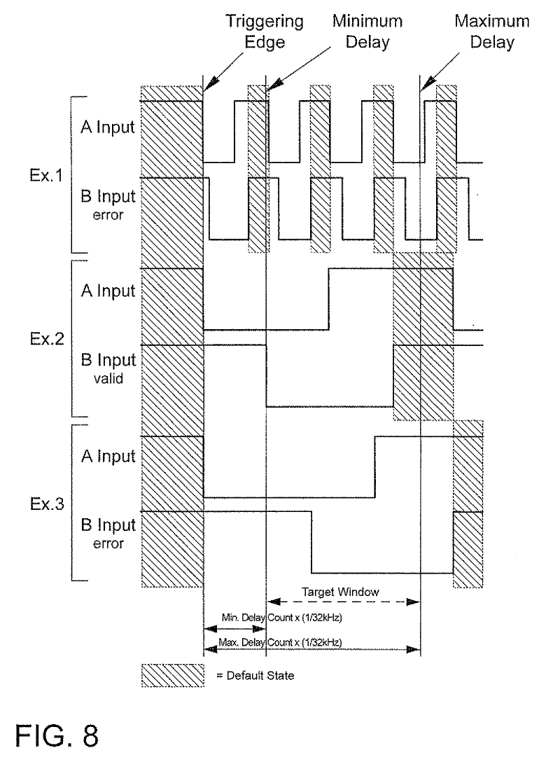

The control unit 25 monitors if the A and B signal transitions occur within a certain window of time. This is to prevent the rotary member 3 from being turned too fast or too slow. Parameters defining this window are factory programmable variables. This error monitoring works as follows: Once a debounced transition is detected, counter based timers ensure that the next transition does not occur before the minimum rotation time (too fast) or the maximum rotation time (too slow). FIG. 8 shows some examples of signal transitions during an actuation of the jog dial actuating device. In these examples the falling edge of the A signal triggers the counters. This indicates that the signals have left their default state and a rotation has begun. A state machine then looks for the signals to transition through and return to their default states. The delay counters ensure that it is done within the specified target window. FIG. 8 shows three examples:
In example 1: the rotation of the rotary member 3 is too fast and the rotation is completed before the minimum delay time expires.
In example 2: the speed of rotation falls within the target window. The minimum delay time has expired and the maximum delay time has not expired.
In example 3: the rotation of the rotary member 3 is too slow and the maximum delay time expires before a full rotation has completed.

The jog dial actuating device 1 of the present invention provides the same functionality as a conventional jog dial wheel 20, but requires much less installation space. However, the present invention is not limited to the embodiments described above. For example more than one switch 6 may be mounted between the rotary members 3, 4 for providing several different actuations due to an force applied in the direction of arrow 13 depending on the location where the force is applied. Furthermore, more than two rotary members may be used and enclosed by the longitudinal member for providing a more complex formed actuating area of the longitudinal member 2 exposed to the user or for providing more space for the one or several switches 6. Furthermore, the longitudinal member 2 is not restricted to the belt-like member with the ribs shown in the embodiments above, but may be any kind of chain, belt, or track having any kind of non-slipping outer circumferential surface. The inner circumferential surface of the longitudinal member and the outer circumferential surface of the rotary members may be such that the longitudinal member engages in the rotary member, e.g. by using a V-belt or a tooth belt. This may provide a reliable engagement and guiding of the longitudinal member. Additionally, the jog dial actuating device 1 is not restricted to the application of selecting items of a graphical user interface as shown in combination with FIG. 4, but may be used for any other applicable usage, for example as a volume control for a loudspeaker or an earspeaker, or an illumination control of a display. Finally, the jog dial actuating device 1 may be installed such that the whole mechanism comprising the longitudinal member 1, the rotary members 3, 4, the sensor 5, and the switch 6 is tiltable by a user actuation in a direction perpendicular to the arrows 11 and 13 of FIG. 2 to provide another actuating direction, e.g. for scrolling or moving items of a graphical user interface in a left/right direction.

What is claimed is:

1. A jog dial actuating device, comprising:
a longitudinal member,
at least two rotary members with the longitudinal member being movably guided around the at least two rotary members, and
a sensor for detecting a movement of the longitudinal member around the at least two rotary members.

2. The jog dial actuating device according to claim 1, wherein the at least two rotary members have a groove with the longitudinal member being guided in the groove.

3. The jog dial actuating device according to claim 1, wherein the longitudinal member is provided with a plurality of protrusions on an outer circumferential surface thereof.

4. The jog dial actuating device according to claim 1, wherein the longitudinal member is provided with a plurality of ribs on an outer circumferential surface thereof, the ribs being essentially aligned in a direction perpendicular to a longitudinal direction of the longitudinal member.

5. The jog dial actuating device according to claim 4, wherein the sensor is adapted to detect a movement of the ribs.

6. The jog dial actuating device according to claim 1, wherein the sensor is coupled to at least one of the rotary members and adapted to detect a rotation of the at least one rotary member.

7. The jog dial actuating device according to claim 1, wherein the sensor is adapted to detect a moving direction of the longitudinal member in a longitudinal direction thereof.

8. The jog dial actuating device according to claim 1, wherein the sensor is adapted to detect a degree of movement of the longitudinal member around the at least two rotary members.

9. The jog dial actuating device according to claim 1, wherein the jog dial actuating device comprises two rotary members encompassed by the longitudinal member in such a way that the longitudinal member has essentially no slack when running around the two rotary members, the sensor being coupled to at least one of the rotary members and adapted to detect a rotation of the at least one rotary member and arranged in an area between the two rotary members and enclosed by the longitudinal member.

10. The jog dial actuating device according to claim 1, wherein the jog dial actuating device comprises a switch, the switch being arranged at a position between the at least two rotary members and adjacent to the longitudinal member such the switch is operable when the longitudinal member is moved in a direction perpendicular to a longitudinal direction of the longitudinal member.

11. The jog dial actuating device according to claim 1, wherein the longitudinal member is a flexible longitudinal member.

12. The jog dial actuating device according to claim 1, wherein the longitudinal member comprises at least one of a belt, a chain and a track.

13. The jog dial actuating device according to claim 1, wherein the at least two rotary members are pulleys.

14. A jog dial actuating device comprising:
a longitudinal member, the longitudinal member being provided with a plurality of ribs on an outer circumferential surface thereof, the ribs being essentially aligned in a direction perpendicular to a longitudinal direction of the longitudinal member,
a first rotary member and a second rotary member with the longitudinal member being movably guided around the first rotary member and the second rotary member, the first rotary member and the second rotary member being encompassed by the longitudinal member in such a way that the longitudinal member has essentially no slack when running around the two rotary members, and
a sensor coupled to the first rotary member for detecting a movement of the longitudinal member around the first rotary member and the second rotary member.

15. The jog dial actuating device according to claim 14, wherein the jog dial actuating device furthermore comprises a switch, the switch being arranged at a position between the first rotary member and the second rotary member and adjacent to the longitudinal member such the switch is operable when the longitudinal member is moved in a direction perpendicular to a longitudinal direction of the longitudinal member.

16. An electronic device comprising
a jog dial actuating device, and
a housing for housing the jog dial actuating device, wherein the jog dial actuating device comprises:
a longitudinal member,
at least two rotary members with the longitudinal member being movably guided around the at least two rotary members, and
a sensor for detecting a movement of the longitudinal member around the at least two rotary members,
wherein the housing is provided with a notch in a surface of the housing and the jog dial actuating device is mounted in such a way in the housing that a part of the longitudinal member is protruding from the surface of the housing through the notch such that the longitudinal member can be actuated in a longitudinal direction of the longitudinal member from outside the housing.

17. The electronic device according to claim 16, wherein the electronic device further comprises a control unit housed in the housing and connected to the sensor of the jog dial actuating device, the control unit being adapted to receive signals from the sensor to process the detected movement of the longitudinal member.

18. The electronic device according to claim 16, wherein the electronic device is a device selected from the group comprising a mobile device, mobile phone, a personal digital assistant, a mobile navigation system, and a mobile computer
